(19) United States
(12) Patent Application Publication
(10) Pub. No.: US 2018/0143086 A1
(43) Pub. Date: May 24, 2018

(54) COOKING TEMPERATURE SENSOR WITH SUBMERSED PROBE

(71) Applicant: ELECTROLUX HOME PRODUCTS, INC., Charlotte, NC (US)

(72) Inventors: Paul Stoufer, Lincolnton, NC (US); John Taylor, Cornelius, NC (US); Chris Hoy, Charlotte, NC (US); Thomas Josefsson, Concord, NC (US)

(73) Assignee: ELECTROLUX HOME PRODUCTS, INC., Charlotte, NC (US)

(21) Appl. No.: 15/812,262

(22) Filed: Nov. 14, 2017

Related U.S. Application Data
(60) Provisional application No. 62/425,473, filed on Nov. 22, 2016.

(51) Int. Cl. G01K 13/00; A47J 36/32; G01K 1/14; G01K 1/02

(52) U.S. Cl. CPC G01K 13/00; A47J 36/32; G01K 2207/06; G01K 1/024; G01K 1/146

(57) ABSTRACT

A temperature sensor is provided for measuring a temperature of a liquid contained in a cooking vessel. The temperature sensor includes a first housing containing processing and wireless communication circuitry, a second housing containing a temperature probe, and a connecting member carrying wiring that connects the processing and wireless communication circuitry to the temperature probe. The temperature sensor also includes a fastener coupled to the first housing and configured to removably affix the temperature sensor to a sidewall of a cooking vessel such that the first housing is exterior to the cooking vessel, and the second housing extends over an interior bottom surface of the cooking vessel. The temperature probe is extendible from or retractable into the second housing to an adjustable height above the interior bottom surface of the cooking vessel and configured to measure a temperature of a liquid contained in the cooking vessel.

### CROSS-REFERENCE SECTION

This application claims the benefit of provisional patent application Ser. No. 62/425,473, filed Nov. 22, 2016. The aforementioned related provisional patent application is herein incorporated by reference in its entirety.

### TECHNOLOGICAL FIELD

The present disclosure relates generally to cooking appliances and, in particular, to a cooking temperature sensor with submersed probe.

### BACKGROUND

Some cooking appliances provide fast heating of liquid within cooking vessels. However, fast heating of liquid within cooking vessels may cause scorch of the cooking vessels which may ruin food products being prepared in the cooking vessels. Therefore it would be desirable to have an apparatus and method that monitor temperature of heated liquid within cooking vessels to enable fast heating of liquid within cooking vessels without risk of scorching.

### BRIEF SUMMARY

Example implementations of the present disclosure are directed to an apparatus and method for measuring a temperature of a liquid contained in a cooking vessel. Example implementations provide fast heating of liquid within the cooking vessel without risk of scorching.

The present disclosure includes, without limitation, the following example implementations.

Some example implementations provide a temperature sensor comprising: a first housing containing processing and wireless communication circuitry; a second housing containing a temperature probe; a connecting member coupled to and between the first housing and the second housing, the connecting member carrying wiring that connects the processing and wireless communication circuitry to the temperature probe; and a fastener coupled to the first housing and configured to removably affix the temperature sensor to a sidewall of a cooking vessel such that the first housing is exterior to the cooking vessel, and the second housing extends over an interior bottom surface of the cooking vessel, wherein the temperature probe is extendible from or retractable into the second housing to an adjustable height above the interior bottom surface of the cooking vessel, and wherein the temperature probe is configured to: measure a temperature of a liquid contained in the cooking vessel, and produce a temperature measurement corresponding thereto; and transmit the temperature measurement to the processing and wireless communication circuitry via the wiring, and wherein the processing and wireless communication circuitry is configured to wirelessly transmit the temperature measurement to a computing device for display thereby.

In some example implementations of the temperature sensor of any preceding example implementation, or any combination of preceding example implementations, the fastener comprises a torsion spring clip mounted to a bottom surface of the first housing, and the torsion spring clip includes a lever biased against an outside surface of the sidewall of the cooking vessel when the temperature sensor is affixed to the sidewall.

In some example implementations of the temperature sensor of any preceding example implementation, or any combination of preceding example implementations, the first housing is cylindrical, and the connecting member is coupled to and extends from the first housing perpendicular to the bottom surface, and wherein when the temperature sensor is affixed to the sidewall of the cooking vessel, the torsion spring clip biases the connecting member against an inside surface of the sidewall opposite the lever biased against the outside surface of the sidewall.

In some example implementations of the temperature sensor of any preceding example implementation, or any combination of preceding example implementations, the first housing and connecting member are monolithic.

In some example implementations of the temperature sensor of any preceding example implementation, or any combination of preceding example implementations, the temperature probe includes a mechanical stop configured to limit extension of the temperature probe from the second housing.

In some example implementations of the temperature sensor of any preceding example implementation, or any combination of preceding example implementations, the wiring is potted in a groove in the connecting member.

In some example implementations of the temperature sensor of any preceding example implementation, or any combination of preceding example implementations, the second housing is formed of a heat resistant thermoplastic material.

In some example implementations of the temperature sensor of any preceding example implementation, or any combination of preceding example implementations, the second housing and the connecting member define an indentation to accommodate a lid placed onto the cooking vessel when the temperature sensor is affixed to the sidewall of the cooking vessel.

In some example implementations of the temperature sensor of any preceding example implementation, or any combination of preceding example implementations, the indentation is exposed between a top surface of the second housing and the connecting member.

In some example implementations of the temperature sensor of any preceding example implementation, or any combination of preceding example implementations, the first housing further contains power harvesting circuitry configured to: receive radio-frequency (RF) energy from an external RF transmitter; and harvest power from the RF energy to power the temperature sensor.

In some example implementations of the temperature sensor of any preceding example implementation, or any combination of preceding example implementations, the processing and wireless communication circuitry is embodied as a system on chip (SoC) that incorporates or is coupled to a wireless communication interface.

Some example implementations provide a method of measuring a temperature of a liquid contained in a cooking vessel using a temperature sensor, wherein the temperature sensor comprises a first housing containing processing and wireless communication circuitry, a second housing containing a temperature probe, and a connecting member coupled to and between the first housing and the second housing, the connecting member carrying wiring that connects the processing and wireless communication circuitry to the temperature probe, the method comprising: removably affixing the temperature sensor to a sidewall of the cooking vessel using a fastener coupled to the first housing, the temperature sensor being affixed such that the first housing is exterior to the cooking vessel, and the second housing extends over an interior bottom surface of the cooking vessel, wherein the temperature probe is extendible from or retractable into the second housing to an adjustable height above the interior bottom surface of the cooking vessel; measuring the temperature of the liquid contained in the cooking vessel, and producing a temperature measurement corresponding thereto, using the temperature probe; transmitting the temperature measurement from the temperature probe to the processing and wireless communication circuitry via the wiring; and wirelessly transmitting the temperature measurement using the processing and wireless communication circuitry, the temperature measurement being wirelessly transmitted to a computing device for display thereby.

In some example implementations of the method of any preceding example implementation, or any combination of preceding example implementations, the fastener comprises a torsion spring clip mounted to a bottom surface of the first housing, and removably affixing the temperature sensor includes biasing a lever of the torsion spring clip against an outside surface of the sidewall of the cooking vessel.

In some example implementations of the method of any preceding example implementation, or any combination of preceding example implementations, the first housing is cylindrical, and the connecting member is coupled to and extends from the first housing perpendicular to the bottom surface, and wherein removably affixing the temperature sensor further includes the torsion spring clip biasing the connecting member against an inside surface of the sidewall opposite the lever biased against the outside surface of the sidewall.

In some example implementations of the method of any preceding example implementation, or any combination of preceding example implementations, the first housing further comprises power harvesting circuitry, and the method further comprises: receiving radio-frequency (RF) energy from an external RF transmitter using the power harvesting circuitry; and harvesting power from the RF energy to power the temperature sensor using the power harvesting circuitry.

These and other features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying drawings which illustrate, by way of example, the principles of some described example implementations.

### BRIEF DESCRIPTION OF THE DRAWING(S)

Having thus described example implementations of the disclosure in general terms, reference will now be made to the accompanying drawings, which are not necessarily drawn to scale, and wherein:

FIG. 1 illustrates a temperature sensor according to example implementations of the present disclosure;

FIG. 2 illustrates a portion of the temperature sensor of FIG. 1, highlighting a torsion spring clip of the temperature sensor according to various example implementations;

FIG. 3 illustrates the temperature sensor of FIG. 1 from an upward view, according to various example implementations;

FIG. 4 illustrates the temperature sensor of FIG. 1 affixed to a cooking vessel and showing a movable temperature probe, according to various example implementations;

FIG. 5 illustrates measuring a temperature of a liquid contained in a cooking vessel using the temperature sensor of FIG. 1, according to various example implementations;

FIG. 6 illustrates the temperature sensor of FIG. 1 with an indentation to accommodate a lid placed onto a cooking vessel to which the temperature sensor is affixed, according to various example implementations;

FIG. 7 illustrates processing and wireless communication circuitry in the temperature sensor of FIG. 1, according to various example implementations; and

FIG. 8 is a flowchart illustrating various steps in a method of measuring a temperature of a liquid contained in a cooking vessel using the temperature sensor of FIG. 1, according to various example implementations.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. For example, unless otherwise indicated, reference something as being a first, second or the like should not be construed to imply a particular order. Also, something may be described as being above something else (unless otherwise indicated) may instead be below, and vice versa; and similarly, something described as being to the left of something else may instead be to the right, and vice versa. Like reference numerals refer to like elements throughout.

Example implementations of the present disclosure are generally directed to cooking appliances and, in particular, to a cooking temperature sensor with submersed probe.

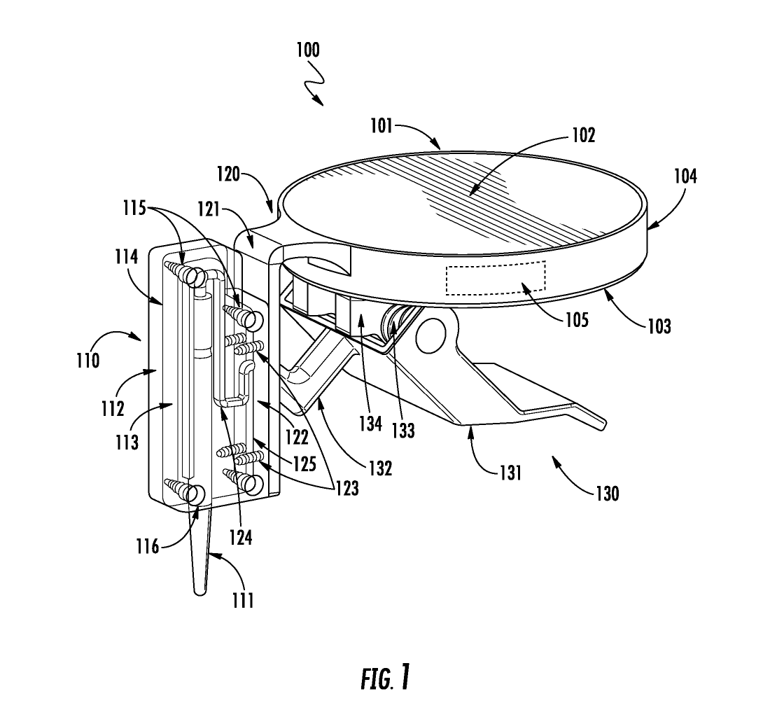

FIG. 1 illustrates a temperature sensor 100 according to example implementations of the present disclosure. The temperature sensor 100 includes a first housing 101. The first housing 101 can be made from metal or plastic. As shown in FIG. 1, in some examples, the first housing 101 is cylindrical, having a top surface 102, a bottom surface 103 and a sidewall 104. The top surface 102 and the bottom surface 103 are opposite to each other. The sidewall 104 is perpendicular to the top surface 102 and the bottom surface 103. The first housing 101 contains processing and wireless communication circuitry 105 to process and transmit temperature measurements of liquid contained in a cooking vessel, as will be described below.

As also shown, the temperature sensor 100 includes a second housing 110 containing a temperature probe 111. The second housing 110 can be made from transparent or translucent plastic such that components inside the second housing 110 are at least partially visible through the second housing 110, although the second housing can also be made from other materials that may or may not be transparent or translucent. The second housing 110 may have a clamshell design with two parts to accommodate assembly of the temperature probe 111 into the second housing 110. For example, as shown in FIG. 1, the second housing 110 includes two halves 112 and 113. When assembling the second housing 110, the temperature probe 111 is first disposed into the second housing 110 (e.g., the first half 112 or the second half 113), and then the two halves 112 and 113 are sealed at the seam 114 by using the screws 115 such that the temperature probe 111 is included inside the second housing 110. In some examples, the second housing 110 is formed of a heat resistant thermoplastic material such as ULTEM™ thermoplastic material. In some examples, the temperature probe 111 is extendible from or retractable into the second housing 110 via an opening 116 at the bottom surface of the second housing 110. The temperature probe 111 is used to measure the temperature of liquid contained in cooking vessels, as will be described below.

The temperature sensor 100 also includes a connecting member 120 that connects the first housing 101 and the second housing 110. In some examples, the connecting member 120 is coupled to the first housing 101. For example, as shown in FIG. 1, the connecting member 120 is affixed to the sidewall 104 of the first housing 101. In some examples, the connecting member 120 extends from the first housing 101. As also shown, the connecting member 120 includes a joint 121 that is coupled to an extended portion 122 of the connecting member 120. In a default position, the extended portion 122 is perpendicular to the bottom surface 103 of the first housing 101. As shown in FIG. 1, a sidewall of the second housing 110 is mounted to the extended portion 122 of the connecting member 120 using screws 123. In some examples, the first housing 101 and the connecting member 120 are monolithic, i.e., constructed as a single piece.

The connecting member 120 carries wiring 124 connecting the processing and wireless communication circuitry 105 to the temperature probe 111. One end of the wiring 124 can be connected to the top end of the temperature probe 111 as shown in FIG. 1, and the other end of the wiring 124 can be hidden inside the first housing 101 and connect to the processing and wireless communication circuitry 105 (not shown in FIG. 1 for simplicity of illustration). The wiring 124 can be a jacketed cable. Part of the wiring 124 is disposed inside the second housing 110 and another part of the wiring 124 is disposed inside the connecting member 120 and/or the first housing 101. In some examples, the wiring 124 is potted into a thin plastic wall or in a groove 125 in the connecting member 120 for sealing.

The temperature sensor 100 also includes a fastener such as a torsion spring clip 130 coupled to the first housing 101. In some examples, as shown in FIG. 1, the torsion spring clip 130 is mounted to the bottom surface 103 of the first housing 101. The torsion spring clip 130 includes one or more torsion springs 133, and a lever 132 coupled to a clip handle 131.

The clip handle 131 of the torsion spring clip 130 is movable or rotatable relative to the torsion springs 133. In a default position, the lever 132 is biased against the extended portion 122 of the connecting member 120, as shown in FIG. 1.

The clip handle 131 of the torsion spring clip 130 has typical thumb to forefinger distances to facilitate the ergonomics of the squeeze movement of the torsion spring clip 130. The default position of the torsion spring clip 130 can be supported and held at rest by tabs 134 on the first housing 101. Thus, the torsion spring clip 130 does not impose pressure on the second housing 110. The first housing 101 supports the torsion springs 133 of the torsion spring clip 130 and maintains the force and moments produced by the torsion springs 133 between the contact point on the outside surface of the sidewall of the cooking vessel and the contact point on the inside surface of the sidewall of the cooking vessel. Thus, the top surface 102 of the first housing 101 is not subjected to the forces or moments produced by the torsion springs 133 of the torsion spring clip 130.

The torsion springs 133 of the torsion spring clip 130 can be captivated by using indentations in the first housing 101 and the torsion spring clip 130. During assembly of the torsion spring clip 130, the torsion springs 133 move axially to locate the first housing 101 relative to the torsion spring clip 130. Then legs of the torsion springs 133 move to the indentations and thus captivate the torsion springs 133 along the bosses of the first housing 101.

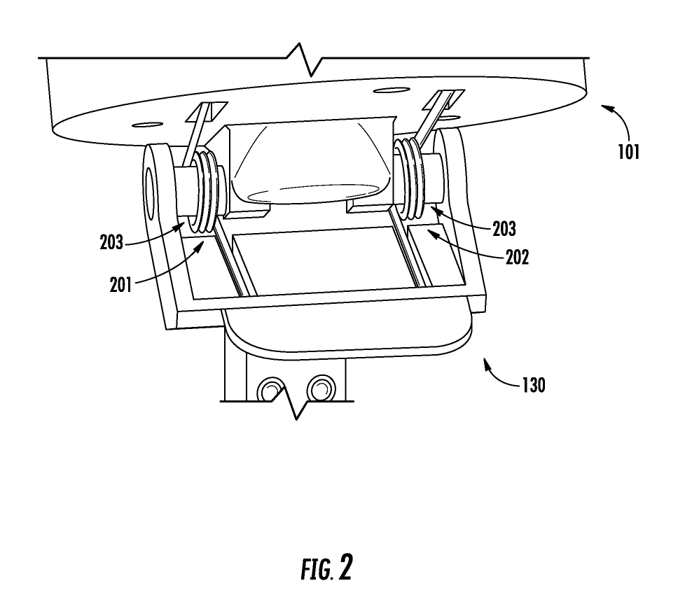

FIG. 2 highlights the torsion spring clip 130 of the temperature sensor 100, according to various example implementations. As shown, in some implementations, the torsion spring clip includes two torsion springs 201 and 202 that are engaged to respective shafts 203 of a base of the torsion spring clip. The two torsion springs are used to grasp the inside surface and outside surface of a sidewall of a cooking vessel. As shown, in one example, the two torsion springs are directly opposed to each other. The force and contact points of the torsion spring clip are designed to accommodate various diameters of cooking vessels and thickness of cooking vessel sidewalls that were measured on available cooking vessels.

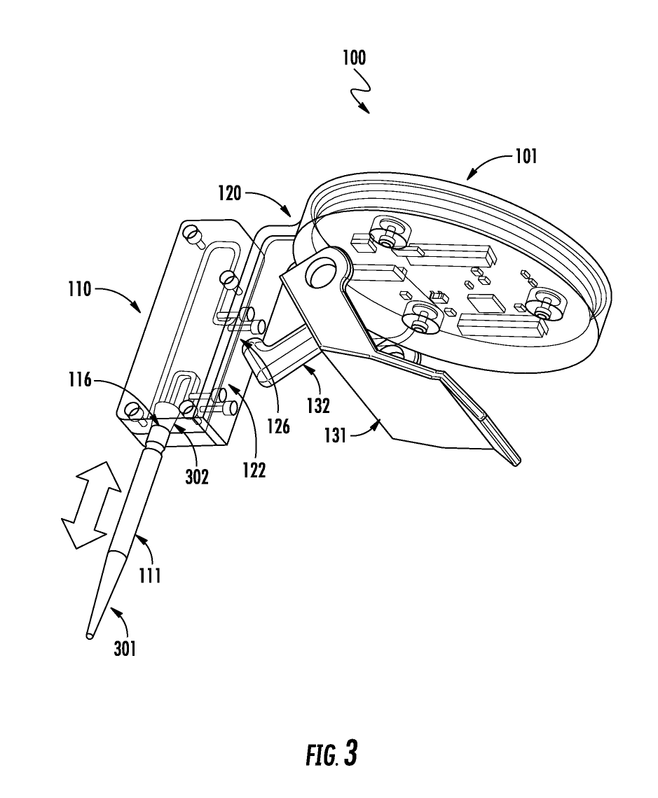

FIG. 3 illustrates the temperature sensor 100 of FIG. 1 from an upward view, according to various example implementations. As shown in FIG. 3, the extended portion 122 of the connecting member 120 includes a mechanical stop 126 that is used to limit movement of the lever 132 of relative to the portion 122 when the lever 132 is biased against the portion 122. For example, when the lever 132 is biased against the portion 122, the lever 132 cannot contact the portion 122 at a position higher than the mechanical stop 126.

The temperature probe 111 is extendible from or retractable into the second housing 110 via the opening 116 at the bottom surface of the second housing 110, as indicated by the double arrow in FIG. 3. The head 301 of the temperature probe 111 may include one or more temperature sensors to measure temperatures of liquid. In some examples, the temperature probe 111 includes a mechanical stop 302 configured to limit extension of the temperature probe 111 from the second housing 110. The part of the temperature probe 111 above the mechanical stop cannot extend below the opening 116 because the part is stopped by the mechanical stop. In one example, the mechanical stop can be a flared part at the top end of the temperature probe. The top end of the temperature probe has a larger diameter than the diameter of the opening to limit extension of the temperature probe from the second housing.

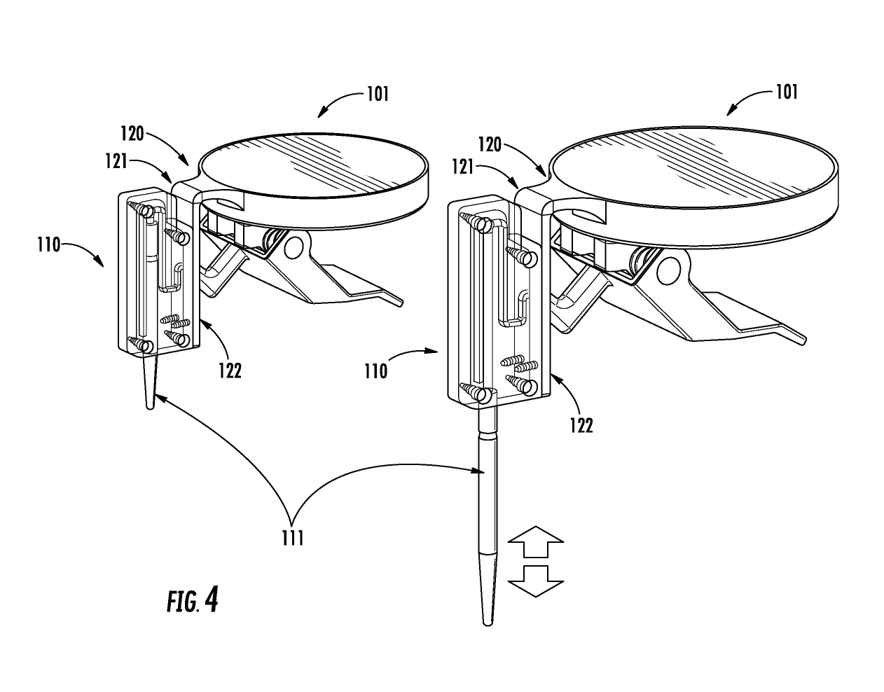

FIG. 4 illustrates the temperature sensor 100 of FIG. 1 showing that the temperature probe 111 extends from or retracts into the second housing 110, according to various example implementations. As indicated by the double arrow in FIG. 4, the temperature probe 111 can extend from or retract into the second housing 110 along the portion 122 of the connecting member 120 when the second housing 110 is mounted to the movable portion 122. When the portion 122 of the connecting member 120 is vertical, the temperature probe 111 also extends from or retracts into the second housing 110 vertically.

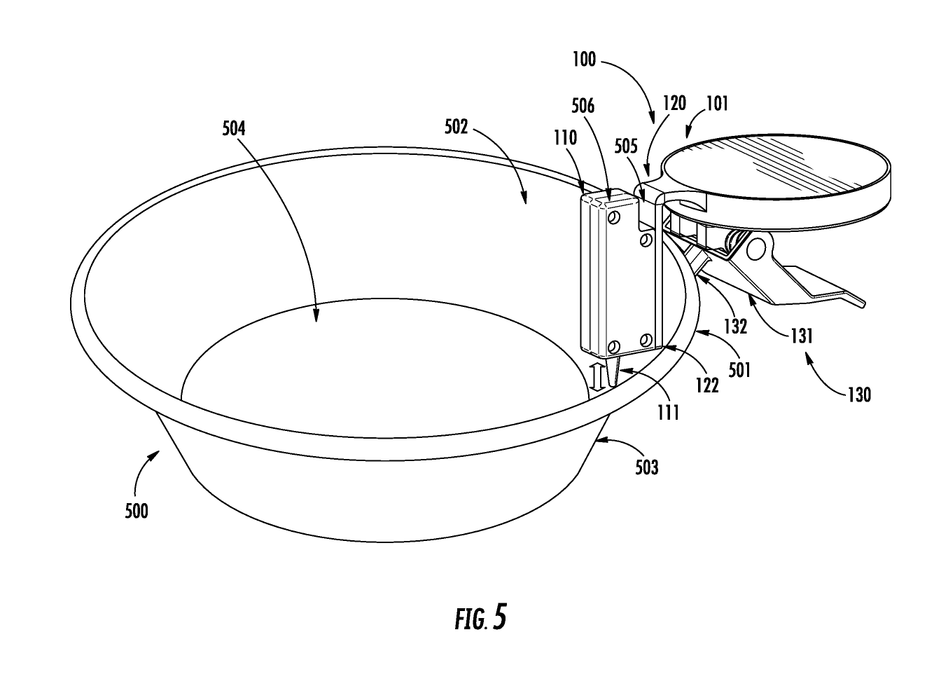

FIG. 5 illustrates measuring a temperature of a liquid contained in a cooking vessel using the temperature sensor 100, according to various example implementations. As shown, when using the temperature sensor 100 to measure the temperature of liquid contained in the cooking vessel 500, the user can use the fastener (e.g., torsion spring clip 130) of the temperature sensor 100 to removably affix the temperature sensor 100 to the sidewall 501 of the cooking vessel 500. The height of the sidewall 501 may be in a range of 2.75-5 inches. For example, the user can use the torsion spring clip 130 to grasp the inside surface 502 and outside surface 503 of the sidewall 501 of the cooking vessel 500. In this way, the temperature sensor 100 is clipped to the sidewall 501 of the cooking vessel 500 such that the first housing 101 is exterior to the cooking vessel 500, and the second housing 110 extends over an interior bottom surface 504 of the cooking vessel 500.

As shown in FIG. 5, when the temperature sensor 100 is affixed to the sidewall 501 of the cooking vessel 500, the lever 132 is biased against the outside surface 503 of the sidewall 501 of the cooking vessel 500. Also, as shown in FIG. 5, when the temperature sensor 100 is affixed to the sidewall 501 of the cooking vessel 500, the torsion spring clip 130 biases the portion 122 of the connecting member 120 against the inside surface 502 of the sidewall 501 opposite the lever 132 biased against the outside surface 503 of the sidewall 501. 5050

In some examples, the second housing 110 and the portion 122 of the connecting member 120 define an indentation 505 to accommodate a lid placed onto the cooking vessel 500 when the temperature sensor 100 is affixed to the sidewall 501 of the cooking vessel 500. As shown in FIG. 5, the indentation 505 is exposed between the top surface 506 of the second housing 110 and the portion 122 of the connecting member 120.

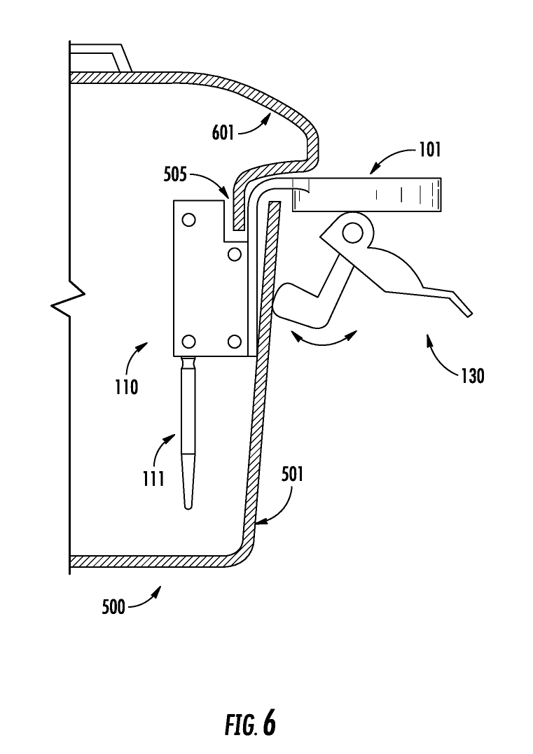

FIG. 6 illustrates placing a lid onto the cooking vessel 500 when the temperature sensor 100 is affixed to the sidewall 501 of the cooking vessel, according to various example implementations. As shown, a lid 601, e.g., a pot lid of the cooking vessel, is placed onto the cooking vessel via the indentation 505 when the temperature sensor is affixed to the sidewall of the cooking vessel. The indentation allows the lid of the cooking vessel to be put in place without causing a gap between the lid and the cooking vessel after hanging the temperature sensor on the sidewall of the cooking vessel.

Referring back to FIG. 5, the temperature probe 111 can extend from or retract into the second housing 110 to an adjustable height above the interior bottom surface 504 of the cooking vessel 500, as indicated by the double arrow in FIG. 5. When the cooking vessel 500 contains liquid that is heated by a cooking appliance, the temperature probe 111 can extend from the second housing 110 such that the one or more temperature sensors included in the temperature probe 111 are submersed into the liquid to measure temperatures of the liquid. As described above, the one or more temperature sensors can be included in the head 301 of the temperature probe 111 as shown in FIG. 3. In some examples, the temperature probe 111 can extend from or retract into the second housing 110 to different adjustable heights above the interior bottom surface 504 to measure temperatures of different depths of the liquid in the cooking vessel 500. The second housing 110 may contain more than one temperature probe 111 to measure temperatures of different locations of the liquid in the cooking vessel 500. The temperature probe 111 can touch the interior bottom surface 504 of the cooking vessel 500.

The temperature probe 111 can produce temperature measurements of the liquid in the cooking vessel 500 and transmit the temperature measurements to the processing and wireless communication circuitry 105 via the wiring 124. The processing and wireless communication circuitry 105 can wirelessly transmit the temperature measurements to a computing device for display thereby to a user, as will be described below. By monitoring the temperature measurements, the computing device can determine whether the cooking vessel 500 is scorching due to high temperature of the liquid contained in the cooking vessel 500. For example, if the computing device determines that the temperature of the liquid contained in the cooking vessel 500 is higher than a predefined threshold, the computing device can turn off or lower the cooking appliance that is heating the liquid to avoid scorching of the cooking vessel 500 for safety.

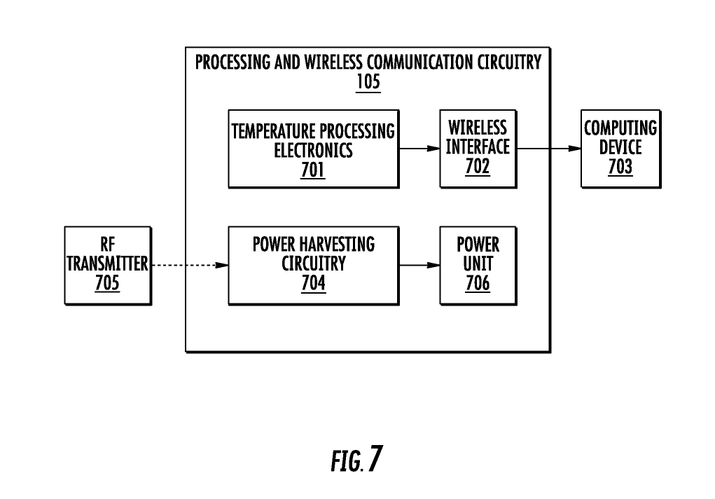

FIG. 7 illustrates processing and wireless communication circuitry 105 in the temperature sensor 100 of FIG. 1, according to various example implementations. As shown in FIG. 7, the processing and wireless communication circuitry 105 includes temperature processing electronics 701 which can read temperatures measured by the temperature probe 111 and wirelessly transmit the temperature measurements via a wireless interface 702 to a computing device 703. In some examples, the temperature processing electronics 701 first convert the temperature measurements into a data format that can be received by the computing device 703. After the conversion, the temperature processing electronics 701 wirelessly transmit the converted data to the computing device 703 via the wireless interface 702. The wireless communication interface 702 may include a Bluetooth Low Energy (BLE) interface. In some examples, the processing and wireless communication circuitry 105 is embodied as a system on chip (SoC) that incorporates the wireless communication interface 702. For example, the SOC incorporates a BLE function to transmit the data to a Bluetooth receiver of the computing device 703. The computing device 703 may be a smartphone or appliance control device for displaying the data to a user or other computing devices as understood in the art. In some examples, the processing and wireless communication circuitry 105 is coupled to a separate wireless communication interface 702 which is not incorporated with the processing and wireless communication circuitry 105 on a SoC.

After receiving the data from the processing and wireless communication circuitry 105, the computing device 703 may monitor the temperatures to predict scorching. If the appliance performs a close loop control of its heating element, the appliance may be controlled by the computing device 703 to provide the fastest heating of liquid within the cooking vessel without risk of scorching.

In some examples, as shown in FIG. 7, the processing and wireless communication circuitry 105 also includes power harvesting circuitry 704. The power harvesting circuitry 704 can receive radio-frequency (RF) signals carrying RF energy from an external RF transmitter 705. For example, RF transmitter 705 can be a 915 MHz RF transmitter that transmits a continuous carrier wave. The harvesting circuitry 704 can convert the received RF energy into a useable DC voltage, which may be stored by a suitable accumulator. Thus, the harvesting circuitry 704 can harvest power from the received RF energy and provide power to the power unit 706 of the processing and wireless communication circuitry 105, which is used to power the temperature sensor 100. With the power harvesting circuitry 704, the temperature sensor 100 can operate using less batteries or without using batteries.

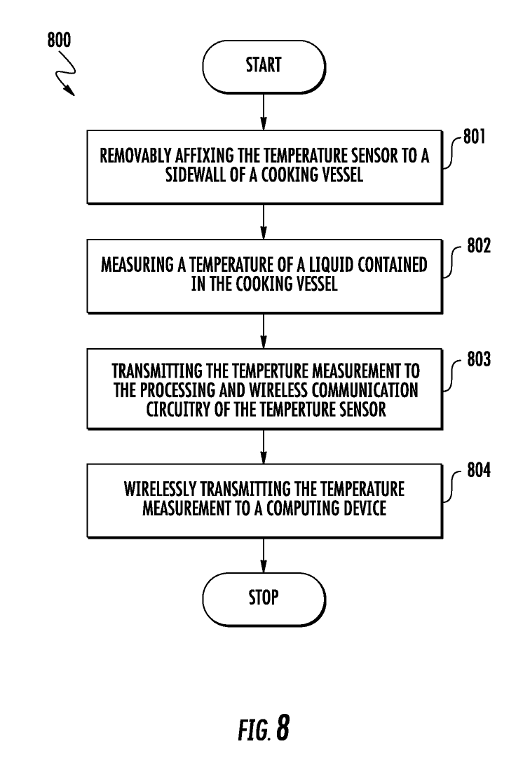

FIG. 8 is a flowchart illustrating various steps in a method 800 of measuring a temperature of a liquid contained in the cooking vessel 500 using the temperature sensor 100 of FIG. 1, according to various example implementations. As described above, the temperature sensor 100 includes the first housing 101 containing processing and wireless communication circuitry 105, the second housing 110 containing the temperature probe 111, and the connecting member 120 coupled to and between the first housing 101 and the second housing 110, the connecting member 120 carrying wiring 124 that connects the processing and wireless communication circuitry 105 to the temperature probe 111.

As shown at block 801, the method 800 includes removably affixing the temperature sensor 100 to a sidewall 501 of the cooking vessel 500 using a fastener (e.g., torsion spring clip 130) coupled to the first housing 101, the temperature sensor 100 being affixed such that the first housing 101 is exterior to the cooking vessel 500, and the second housing 110 extends over an interior bottom surface 504 of the cooking vessel 500, wherein the temperature probe 111 is extendible from or retractable into the second housing 110 to an adjustable height above the interior bottom surface 504 of the cooking vessel 500.

The method 800 also includes measuring a temperature of a liquid contained in the cooking vessel 500, and producing a corresponding temperature measurement, using the temperature probe 111, as shown at block 802. At block 803, the method 800 also includes transmitting the temperature measurement from the temperature probe 111 to the processing and wireless communication circuitry 105 via the wiring 124. At block 804, the method 800 further includes wirelessly transmitting the temperature measurement using the processing and wireless communication circuitry 105, the temperature measurement being wirelessly transmitted to a computing device 703 for display thereby.

Many modifications and other implementations of the disclosure set forth herein will come to mind to one skilled in the art to which the disclosure pertains having the benefit of the teachings presented in the foregoing description and the associated drawings. Therefore, it is to be understood that the disclosure is not to be limited to the specific implementations disclosed and that modifications and other implementations are intended to be included within the scope of the appended claims. Moreover, although the foregoing description and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A temperature sensor comprising:
a first housing containing processing and wireless communication circuitry;
a second housing containing a temperature probe;
a connecting member coupled to and between the first housing and the second housing, the connecting member carrying wiring that connects the processing and wireless communication circuitry to the temperature probe; and
a fastener coupled to the first housing and configured to removably affix the temperature sensor to a sidewall of a cooking vessel such that the first housing is exterior to the cooking vessel, and the second housing extends over an interior bottom surface of the cooking vessel,
wherein the temperature probe is extendible from or retractable into the second housing to an adjustable height above the interior bottom surface of the cooking vessel, and wherein the temperature probe is configured to:
measure a temperature of a liquid contained in the cooking vessel, and produce a temperature measurement corresponding thereto; and
transmit the temperature measurement to the processing and wireless communication circuitry via the wiring, and
wherein the processing and wireless communication circuitry is configured to wirelessly transmit the temperature measurement to a computing device for display thereby.

2. The temperature sensor of claim 1, wherein the fastener comprises a torsion spring clip mounted to a bottom surface of the first housing, and the torsion spring clip includes a lever biased against an outside surface of the sidewall of the cooking vessel when the temperature sensor is affixed to the sidewall.

3. The temperature sensor of claim 2, wherein the first housing is cylindrical, and the connecting member is coupled to and extends from the first housing perpendicular to the bottom surface, and
wherein when the temperature sensor is affixed to the sidewall of the cooking vessel, the torsion spring clip biases the connecting member against an inside surface of the sidewall opposite the lever biased against the outside surface of the sidewall.

4. The temperature sensor of claim 1, wherein the first housing and connecting member are monolithic.

5. The temperature sensor of claim 1, wherein the temperature probe includes a mechanical stop configured to limit extension of the temperature probe from the second housing.

6. The temperature sensor of claim 1, wherein the wiring is potted in a groove in the connecting member.

7. The temperature sensor of claim 1, wherein the second housing is formed of a heat resistant thermoplastic material.

8. The temperature sensor of claim 1, wherein the second housing and the connecting member define an indentation to accommodate a lid placed onto the cooking vessel when the temperature sensor is affixed to the sidewall of the cooking vessel.

9. The temperature sensor of claim 9, wherein the indentation is exposed between a top surface of the second housing and the connecting member.

10. The temperature sensor of claim 1, wherein the first housing further contains power harvesting circuitry configured to:
receive radio-frequency (RF) energy from an external RF transmitter; and
harvest power from the RF energy to power the temperature sensor.

11. The temperature sensor of claim 1, wherein the processing and wireless communication circuitry is embodied as a system on chip (SoC) that incorporates or is coupled to a wireless communication interface.

12. A method of measuring a temperature of a liquid contained in a cooking vessel using a temperature sensor, wherein the temperature sensor comprises a first housing containing processing and wireless communication circuitry, a second housing containing a temperature probe, and a connecting member coupled to and between the first housing and the second housing, the connecting member carrying wiring that connects the processing and wireless communication circuitry to the temperature probe, the method comprising:
removably affixing the temperature sensor to a sidewall of the cooking vessel using a fastener coupled to the first housing, the temperature sensor being affixed such that the first housing is exterior to the cooking vessel, and the second housing extends over an interior bottom surface of the cooking vessel, wherein the temperature probe is extendible from or retractable into the second housing to an adjustable height above the interior bottom surface of the cooking vessel;
measuring the temperature of the liquid contained in the cooking vessel, and producing a temperature measurement corresponding thereto, using the temperature probe;
transmitting the temperature measurement from the temperature probe to the processing and wireless communication circuitry via the wiring; and
wirelessly transmitting the temperature measurement using the processing and wireless communication circuitry, the temperature measurement being wirelessly transmitted to a computing device for display thereby.

13. The method of claim 12, wherein the fastener comprises a torsion spring clip mounted to a bottom surface of the first housing, and removably affixing the temperature sensor includes biasing a lever of the torsion spring clip against an outside surface of the sidewall of the cooking vessel.

14. The method of claim 13, wherein the first housing is cylindrical, and the connecting member is coupled to and extends from the first housing perpendicular to the bottom surface, and
wherein removably affixing the temperature sensor further includes the torsion spring clip biasing the connecting member against an inside surface of the sidewall opposite the lever biased against the outside surface of the sidewall.

15. The method of claim 12, wherein the first housing further comprises power harvesting circuitry, and the method further comprises:
receiving radio-frequency (RF) energy from an external RF transmitter using the power harvesting circuitry; and
harvesting power from the RF energy to power the temperature sensor using the power harvesting circuitry.
